(19) United States
(12) Patent Application Publication
(10) Pub. No.: US 2013/0285940 A1
(43) Pub. Date: Oct. 31, 2013

(54) Touch Type Control Equipment and Method Thereof

(71) Applicant: NATIONAL TAIWAN UNIVERSITY, Taipei (TW)

(72) Inventors: Bing-Yu Chen, Taipei (TW); Kai-Yin Cheng, Taipei City (TW); Rong-Hao Liang, Taipei City (TW); Shu-Yang Lin, Taipei City (TW); Zhao-Huai Su, Yilan County (TW)

(73) Assignee: NATIONAL TAIWAN UNIVERSITY, Taipei (TW)

(21) Appl. No.: 13/674,372

(22) Filed: Nov. 12, 2012

(30) Foreign Application Priority Data
Apr. 30, 2012 (TW) 101115396

(51) Int. Cl. G06F 3/041

(52) U.S. Cl. CPC G06F 3/041
USPC 345/173

(57) ABSTRACT

A distance-tracking touch detection controller operable to enable functions of an electronic device based on a user's gestures and location of touch on his own body. The distance-tracking touch detection controller comprises a distance meter and a control interface coupled with the distance meter. When user touches his own body, the distance meter detects the touched location or the trajectory of touched locations and generates a detecting signal. The control interface is coupled with the distance meter, and the control interface reads the detecting signal to generate a control signal. The control signal is operable to enable one or more functions of an electronic device. Moreover, a method of operating the distance-tracking touch detection controller is presented.

### CROSS-REFERENCE TO RELATED APPLICATION

This application claims priority to Taiwanese Patent Application No. 101,115,396, filed on Apr. 30, 2012, the entirety of which is hereby incorporated by reference.

### BACKGROUND

1. Field of the Invention

The present disclosure relates to digital control equipment and methods thereof, specifically for a distance-tracking touch detection controller.

2. Description of the Related Art

Currently, digital control equipment that remotely operates electronic devices by a user's touch is not convenient. For example, one method uses microphone sensors to determine the location of a user's touch. The microphone sensors are stuck on the skin of the user and detect vibration waves transferred through the skin and bone. However, this method requires the user to tape the microphone sensors to his skin and the size of each microphone sensor is large. An additional sensing method uses capacitance sensors embedded in a garment. However, this sensing method requires the user to wear the special garments designed to detect the touched position, and it is not always convenient for the user to wear the garment. As such, there is a need for an improved distance-tracking touch detection controller for use with an electronic device.

### SUMMARY

The present disclosure describes a distance-tracking touch detection controller operable to control various functions of electronic devices. A distance-tracking touch detection controller includes a distance meter and a control interface coupled with the distance meter. When a user touches his arm, for example, a distance meter detects the touched location or the trajectory of touched locations in order to generate a detecting signal. A control interface is coupled with a distance meter, and the control interface reads a detecting signal in order to generate a control signal operable to control one or more functions of an electronic device.

The present disclosure also describes methods of operating the distance-tracking touch detection controller comprising touching a user's skin; detecting the touched location or trajectory of touched locations to generate a detecting signal by a distance meter; receiving the detecting signal by a control interface; and generating a control signal to output by the control interface to an electronic device.

### BRIEF DESCRIPTION OF THE DRAWINGS

FIG. 1 depicts a schematic view illustrating a distance-tracking touch detection controller operable to control various functions of electronic devices, in accordance with an embodiment of the present disclosure;

FIG. 2 depicts a block diagram illustrating a circuit structure of a distance-tracking touch detection controller, in accordance with an embodiment of the present disclosure;

FIG. 3 depicts a schematic view illustrating use of a distance-tracking touch detection controller, in accordance with an embodiment of the present disclosure;

FIG. 4 depicts a schematic view illustrating use of a distance-tracking touch detection controller, in accordance with an embodiment of the present disclosure;

FIG. 5 depicts a flow chart illustrating a method of operating a distance-tracking touch detection controller, in accordance with an embodiment of the present disclosure; and

FIG. 6 depicts a flow chart illustrating a method of operating the distance-tracking touch detection controller, in accordance with an embodiment of the present disclosure.

### DETAILED DESCRIPTION OF THE EMBODIMENTS

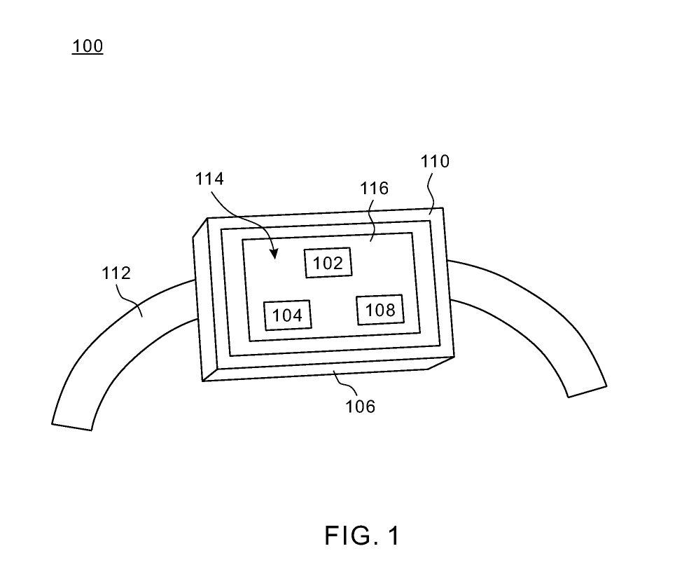

FIG. 1 depicts a schematic view illustrating an embodiment of a distance-tracking touch detection controller 100 operable to control various functions of electronic devices based on a user's gestures and touch on his own body. The electronic device may comprise an MP3 player, a cell phone, a tablet computer, a laptop computer, a stereo, a top, a medical device, a surgical instrument, or any other device that is operable to be controlled by a remote controller. As shown in FIG. 1, the distance-tracking touch detection controller 100 comprises a distance meter 102, a control interface 104, a fastener 106, and a power supply 108. Fastener 106 may be removably affixed to a user's body on the user's wrist, chest, stomach, or any other portion of the body operable to receive the fastener 106. In some embodiments, fastener 106 includes a base 110 and a strap 112, wherein strap 112 is connected with base 110, and fastener 106 can be mounted on the user's wrist with strap 112. A groove 114 may be located at a top surface of base 110 and a circuit board 116 may be mounted in groove 114. Distance meter 102, control interface 104, and power supply 108 may be coupled with circuit board 116.

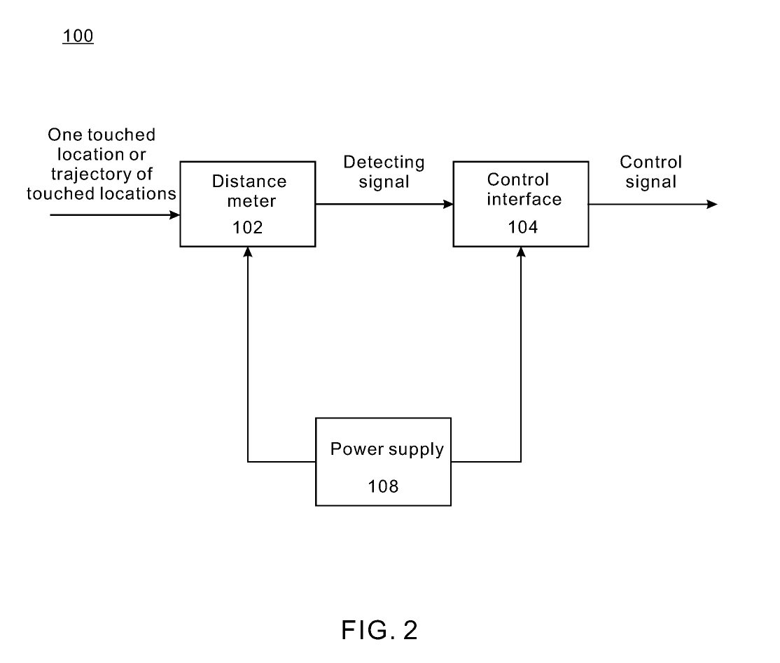

FIG. 2 depicts a block diagram illustrating an embodiment of a circuit structure of distance-tracking touch detection controller 100. As shown in FIG. 2, distance meter 102 can be an ultrasonic distance meter, an infrared distance meter, or a laser distance meter, or any of form of meter operable to determine a distance between two points. For example, if the distance meter 102 is an infrared distance meter, when the user's finger touches his skin, the infrared distance meter may transmit infrared light to the user's finger, and then the infrared light may be reflected from the user's finger back to the infrared distance meter. The infrared distance meter may then be operable to measure the distance between the touched location and the distance meter 102 according to the total transmitted time of the infrared light and the velocity of the infrared light.

After a user touches his or her own skin, distance meter 102 may detect a touched location or a trajectory of touched locations 202 in order to generate a detecting signal 204. Control interface 104 may read detecting signal 204 and generate a control signal 206. Control signal 206 generated by control interface 104 differs each time that touched location or trajectory of touched locations 202 is different. Power supply 108 may be coupled with distance meter 102 and control interface 104, and power supply 108 may provide electrical power to distance meter 102 and control interface 104.

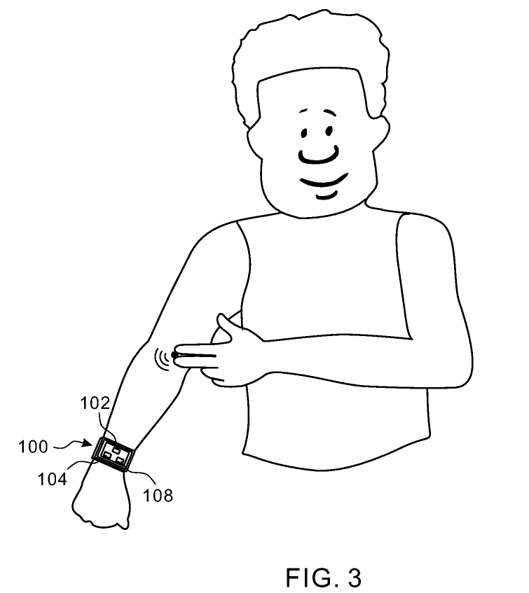

FIG. 3 depicts a schematic view illustrating a first state of use of distance-tracking touch detection controller 100. As shown in FIG. 3, distance-tracking touch detection controller 100 is affixed on the user's wrist. When the user touches the skin of his arm at a touched location 302, for example, distance meter 102 detects touched location 302 and generates a detecting signal. The detecting signal generated by distance meter 102 differs each time that touched location 302 is different. Control interface 104 then reads the detecting signal and generates a control signal. The control signal generated by control interface 104 also differs each time the detecting signal is different. Different control signals may enable different functions of the electronic device. For example, when the electronic device is a MP3 player, the different control signals may enable various functions such as previous song, next song, turn up the volume, turn down the volume, play, pause, etc.

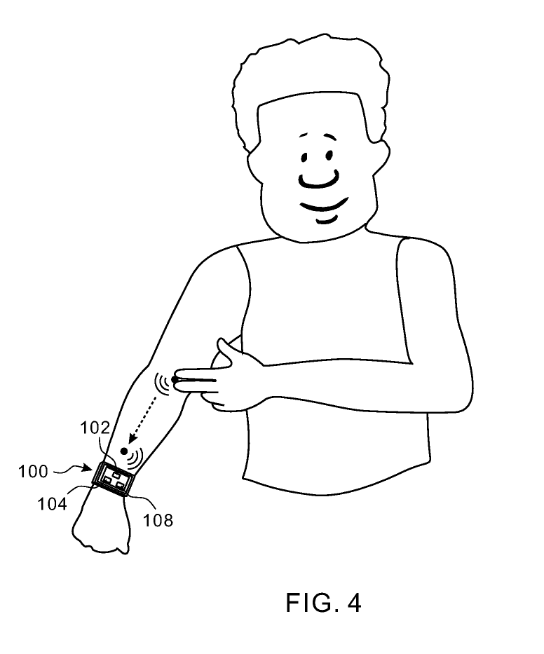

FIG. 4 depicts a schematic view illustrating a second state of use of distance-tracking touch detection controller 100. As shown in FIG. 4, distance-tracking touch detection controller 100 is affixed on the user's wrist. When the user touches the skin of his own arm, distance meter 102 may detect trajectory of touched locations 402 (e.g., the user's finger slides along the user's arm from elbow to wrist). The detecting signal generated by distance meter 102 differs each time that trajectory of touched locations 402 is different. Control interface 104 then reads the detecting signal and generates a control signal. The control signal generated by control interface 104 also differs each time that the detecting signal received by control interface 104 is different. Different control signals may enable different functions of the electronic device. For example, when the electronic device is a MP3 player, the different control signals may enable various functions such as previous song, next song, turn up the volume, turn down the volume, play, pause, etc.

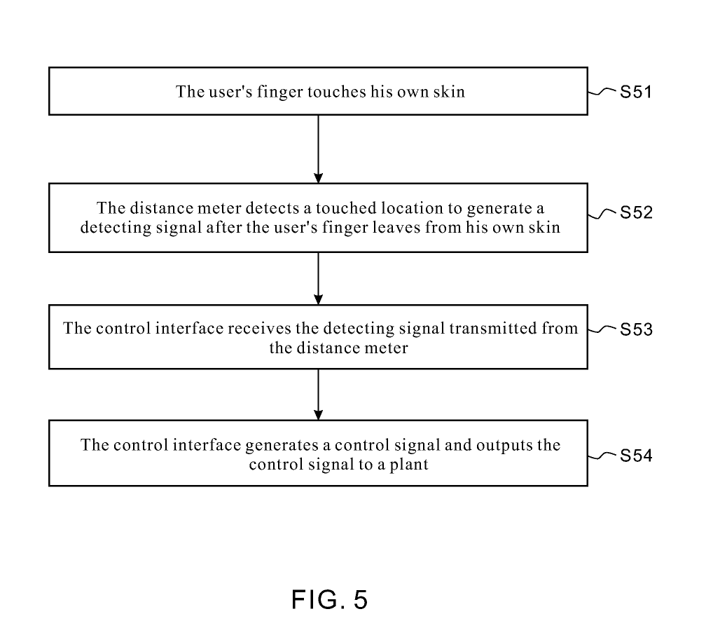

FIG. 5 depicts a flow chart illustrating an embodiment of a method of operating the distance-tracking touch detection controller 100. As shown in FIG. 5, at action S51, the user's finger touches his own skin. At action S52, the distance meter 102 detects a touched location to generate a detecting signal. In some embodiments, distance meter 102 detects the touched location after the user's finger is removed from his own skin (on-leave detection). At action S53, control interface 104 receives the detecting signal transmitted from distance meter 102. At action S54, control interface 104 generates a control signal and outputs the control signal to an electronic device. The control signal generated by control interface 104 differs each time that the touched location is different. Different control signals may enable different functions of the electronic device.

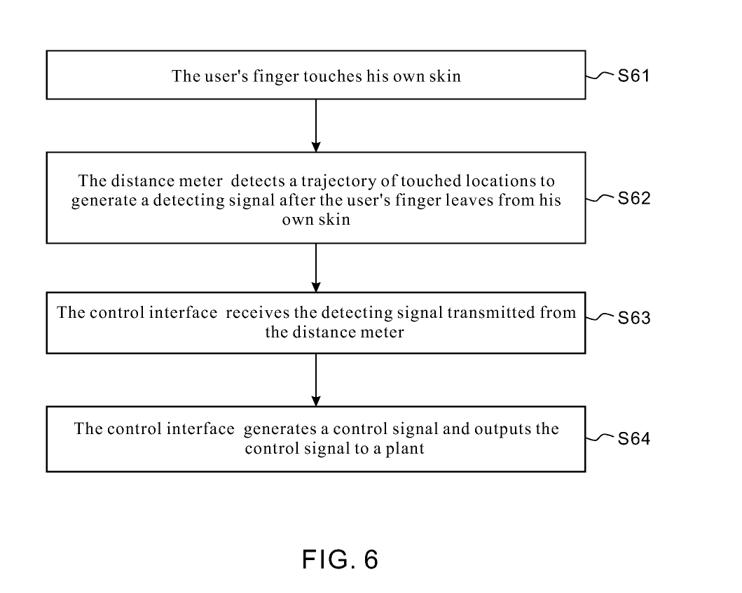

FIG. 6 depicts a flow chart illustrating another embodiment of a method of operating distance-tracking touch detection controller 100. As shown in FIG. 6, at action S61, the user's finger touches his own skin. At action S62, the distance meter 102 detects a trajectory of touched locations to generate a detecting signal. In some embodiments, distance meter 102 detects the touched location after the user's finger is removed from his own skin (on-leave detection). At action S63, control interface 104 receives the detecting signal transmitted from the distance meter 102. At action S64, control interface 104 generates a control signal and outputs the control signal to an electronic device. The control signal generated by control interface 104 differs each time that the touched location is different. Different control signals may be operable to control different functions of the electronic device.

According to the two methods of operating distance-tracking touch detection controller 100, as shown in FIG. 5 and FIG. 6, because distance meter 102 detects the touched location or the trajectory of touched locations after the user's finger leaves from his own skin, the user may have enough time to shift his finger along his skin until he confirms the desired position, such that an eyes-free manner of interaction can be realized.

Some embodiments of the disclosure may advantageously provide a distance-tracking touch detection controller that is small in shape and size and is easily affixed to a user's body. Moreover, the distance meter may be operable to detect the touched location or the trajectory of touched locations after the user's finger leaves his own arm, so that the risk of detecting an incorrect touched location or trajectory of touched locations is reduced. As such, the user may have enough time to shift his finger along his skin to the desired position, allowing an eyes-free manner of interaction with the distance-tracking touch detection controller.

As may be used herein, the terms “substantial,” “substantially,” “approximate,” and “approximately” provide an industry-accepted tolerance for its corresponding term and/or relativity between items. Such an industry-accepted tolerance ranges from less than one percent to ten percent and corresponds to, but is not limited to, component values, angles, et cetera. Such relativity between items ranges between less than one percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A distance-tracking touch detection controller operable to operate an electronic device, comprising:
a distance meter, wherein the distance meter is operable to detect a touched location or a trajectory of touched locations and is operable to generate a detecting signal when a user touches his own body; and
a control interface coupled with the distance meter, wherein the control interface is operable to read the detecting signal in order to generate a control signal.

2. The distance-tracking touch detection controller according to claim 1, wherein the control signal generated by the control interface is different each time that the touched location is different.

3. The distance-tracking touch detection controller according to claim 1, wherein the control signal generated by the control interface is different each time that the trajectory of the touched locations is different.

4. The distance-tracking touch detection controller according to claim 1, wherein the distance meter is an ultrasonic distance meter.

5. The distance-tracking touch detection controller according to claim 1, wherein the distance meter is an infrared distance meter.

6. The distance-tracking touch detection controller according to claim 1, wherein the distance meter is a laser distance meter.

7. The distance-tracking touch detection controller according to claim 1, further comprising a fastener, wherein the distance meter and the control interface are assembled with the fastener, and further wherein the fastener is operable to be affixed to the user's body.

8. The distance-tracking touch detection controller according to claim 7, further comprising a power supply, the power supply is assumed with the fastener, and the power supply is coupled with the distance meter and the control interface.

9. The distance-tracking touch detection controller according to claim 8, wherein the fastener comprises a base and a strap and the strap is connected to the base and a groove is located on a top surface of the base,

10. The distance-tracking touch detection controller according to claim 9, wherein a circuit board is mounted in the groove.

11. The distance-tracking touch detection controller according to claim 10, wherein the distance meter, the control interface, and the power supply are each coupled with the circuit board.

12. A method of operating an electronic device with a distance-tracking touch detection controller, comprising the steps of:
detecting a touched location or a trajectory of touched locations where a user touches his skin in order to generate a detecting signal by a distance meter;
receiving the detecting signal from the distance meter at a control interface; and
generating a control signal to output from the control interface to the electronic device, wherein the control signal is operable to enable different functions of the electronic device.

13. The method of operating the distance-tracking touch detection controller according to claim 12, wherein the distance meter is operable to detect the touched location or the trajectory of touched locations after the user's finger leaves the skin.

14. The method of operating the distance-tracking touch detection controller according to claim 12, wherein the control signal generated by the control interface differs each time when the touched location or the trajectory of touched locations is different, and different control signals respectively enable different functions of the electronic device.

15. The method of operating the distance-tracking touch detection controller according to claim 12, wherein the distance meter is an ultrasonic distance meter.

16. The method of operating the distance-tracking touch detection controller according to claim 12, wherein the distance meter is an infrared distance meter.

17. The method of operating the distance-tracking touch detection controller according to claim 12, wherein the distance meter is a laser distance meter.
